(19) United States
(12) Patent Application Publication
(10) Pub. No.: US 2024/0327623 A1
(43) Pub. Date: Oct. 3, 2024

(54) Molding Material

(71) Applicant: SEIKO EPSON CORPORATION, Tokyo (JP)

(72) Inventors: Shinobu YOKOKAWA, Okaya (JP); Shintaro ASAI, Matsumoto (JP); Hirofumi HOKARI, Chino (JP); Atsushi YAMADA, Chino (JP)

(21) Appl. No.: 18/617,958

(22) Filed: Mar. 27, 2024

(30) Foreign Application Priority Data
Mar. 28, 2023 (JP) 2023-052140

(51) Int. Cl. C08L 1/32; C08B 3/08; C08J 5/04; C08K 5/00

(52) U.S. Cl. CPC C08L 1/32; C08B 3/08; C08J 5/046; C08K 5/005; C08K 5/0066; C08J 2301/02; C08L 2201/02; C08L 2201/08; C08L 2205/025

(57) ABSTRACT

The molding material of the present disclosure includes a cellulose fiber and a specific cellulose derivative in which a part of the hydrogen atoms constituting the hydroxy groups of cellulose is substituted with a chemical structure represented by the following formula (1) or (3) and another part of the hydrogen atoms is substituted with a chemical structure represented by the following formula (2) or (4), wherein the content of the cellulose fiber is 50 mass % or more and 70 mass % or less.

—R_{A} (1)

—R_{C3}—(OR_{C2})ₘ—OR_{C1} (2)

—(C═O)R_{B} (3)

—(C═O)R_{C4}—(OR_{C2})ₙ—OR_{C1} (4)

The present application is based on, and claims priority from JP Application Serial Number 2023-052140, filed Mar. 28, 2023, the disclosure of which is hereby incorporated by reference herein in its entirety.

### BACKGROUND

### 1. Technical Field

The present disclosure relates to a molding material.

### 2. Related Art

As a countermeasure against oil depletion and global warming, attempts are being made to replace existing plastic materials with molding materials that utilize cellulose, which is an abundant natural material derived from plants.

For example, as a non-woven web or composite structure that can be disposed of in a composting landfills, those including natural cellulose fibers and cellulose esters such as cellulose acetate butyrate and cellulose acetate propionate have been proposed (see JP-T-2005-504184).

However, such a molded product has a problem of poor strength, shock resistance, and heat resistance.

### SUMMARY

The present disclosure has been made to solve the above problems, and can be realized as the following application examples.

The molding material according to the application example of the present disclosure includes a cellulose fiber and a specific cellulose derivative in which a part of the hydrogen atoms constituting the hydroxy groups of cellulose is substituted with a chemical structure represented by the following formula (1) or (3) and another part of the hydrogen atoms is substituted with a chemical structure represented by the following formula (2) or (4), wherein the content of the cellulose fiber is 50 mass % or more and 70 mass % or less,

—R_{A} (1)

(in the formula (1), R_{A} is an alkyl group);

—R_{C3}—(OR_{C2})ₘ—OR_{C1} (2)

(in the formula (2), R_{C1} is an alkyl group having 1 to 6 carbon atoms, R_{C2} is an alkylene group having 2 or 3 carbon atoms, R_{C3} is an alkylene group having 3 to 6 carbon atoms, and m is an integer of 3 or more and 6 or less);

—(C═O)R_{B} (3)

(in the formula (3), R_{B} is an alkyl group); and

—(C═O)R_{C4}—(OR_{C2})ₙ—OR_{C1} (4)

(in the formula (4), R_{C1} is an alkyl group having 1 to 6 carbon atoms, R_{C2} is an alkylene group having 2 or 3 carbon atoms, R_{C4} is an alkylene group having 3 to 6 carbon atoms, and n is an integer of 3 or more and 6 or less).

### BRIEF DESCRIPTION OF THE DRAWINGS

FIG. 1 is a table collectively showing conditions of cellulose derivatives synthesized in the respective Synthesis Examples.

FIG. 2 is a table collectively showing the compositions, molding methods, and evaluation results of the molding materials of Examples 1 to 17.

FIG. 3 is a table collectively showing the compositions, molding methods, and evaluation results of the molding materials of Examples 18 to 25 and Comparative Examples 1 to 9.

### DESCRIPTION OF EMBODIMENTS

Suitable embodiments of the present disclosure will now be described in detail.

### [1] Molding Material

A molding material of the present disclosure will be described first.

The molding material of the present disclosure includes a cellulose fiber and a specific cellulose derivative in which a part of the hydrogen atoms constituting the hydroxy groups of cellulose is substituted with a chemical structure represented by the following formula (1) or (3) and another part of the hydrogen atoms is substituted with a chemical structure represented by the following formula (2) or (4), wherein the content of the cellulose fiber in the molding material is 50 mass % or more and 70 mass % or less,

—R_{A} (1)

(in the formula (1), R_{A} is an alkyl group);

—R_{C3}—(OR_{C2})ₘ—OR_{C1} (2)

(in the formula (2), R_{C1} is an alkyl group having 1 to 6 carbon atoms, R_{C2} is an alkylene group having 2 or 3 carbon atoms, R_{C3} is an alkylene group having 3 to 6 carbon atoms, and m is an integer of 3 or more and 6 or less);

—(C═O)R_{B} (3)

(in the formula (3), R_{B} is an alkyl group); and

—(C═O)R_{C4}—(OR_{C2})ₙ—OR_{C1} (4)

(in the formula (4), R_{C1} is an alkyl group having 1 to 6 carbon atoms, R_{C2} is an alkylene group having 2 or 3 carbon atoms, R_{C4} is an alkylene group having 3 to 6 carbon atoms, and n is an integer of 3 or more and 6 or less).

Such a configuration can provide a molding material that includes a cellulose fiber in a prescribed content range, i.e., a sufficiently high content of 50 mass % or more and 70 mass % or less and can be suitably used for manufacturing a molded product excellent in strength, shock resistance, and heat resistance.

The reasons why such excellent effects can be obtained are thought to be as follows: when the molding material includes cellulose having high theoretical strength and excellent shape stability and also includes a specific cellulose derivative having excellent compatibility and affinity with cellulose fibers and having excellent heat resistance and toughness, the functions of these components are prevented or suppressed from cancelling each other, and the functions of these components can be fully exhibited. More specifically, during manufacturing a molded product using a molding material and in a molded product manufactured using a molding material, while fully exhibiting the functions of a cellulose fiber and a specific cellulose derivative, the wettability of the specific cellulose derivative to the cellulose fiber can be increased, and the interfacial peeling between different components constituting the molded product can be suitably prevented and suppressed. As a result, it is thought that the excellent effects mentioned above can be obtained.

Since the interfacial peeling between different components constituting the molded product can be suitably prevented and suppressed, a molded product that effectively prevents problems such as dust generation can be obtained.

When a cellulose fiber, which is an abundant natural material derived from plants, is included at a high content, it is possible to appropriately respond to environmental problems and underground resource saving and so on, and it is also advantageous from the viewpoint of stable supply, cost reduction, and so on of a molding material and a molded product manufactured using it. A cellulose fiber is a component that is included in large amounts in, for example, waste paper and waste cloth in addition to virgin pulp and is also advantageous from the viewpoint of promoting the effective reuse of resources.

The specific cellulose derivative can be suitably obtained using such cellulose described above as a raw material and is a component generally having excellent biodegradability. Consequently, also the entire molding material or the entire molded product manufactured using the molding material can appropriately deal with environmental problems and so on.

In contrast, if the above conditions are not fulfilled, satisfactory results cannot be obtained.

For example, even if the molding material includes a cellulose fiber, if the specific cellulose derivative is not included, the molded product manufactured using the molding material is significantly inferior in strength, shock resistance, and so on.

In addition, when the specific cellulose derivative is not included and another cellulose derivative is used instead of the specific cellulose derivative, the strength, shock resistance, and heat resistance of the molded product manufactured using the molding material are insufficient.

For example, when a cellulose derivative having a chemical structure represented by the above formula (1) or (3) but not having chemical structures represented by the above formulae (2) and (4) is used instead of the specific cellulose derivative, compatibility between the cellulose fiber and other materials contained therein cannot be ensured, and the respective materials are phase-separated to make it impossible guarantee molding properties.

In addition, when a cellulose derivative having a chemical structure represented by the above formula (2) or (4) but not having chemical structures represented by the above formulae (1) and (3) is used instead of the specific cellulose derivative, since the side chain is highly polar, the moisture resistance and water resistance of the molded product are decreased.

When a cellulose derivative having a substituent in which R_{C1} in the formula (2) is a hydrogen atom is used instead of the specific cellulose derivative, interaction between fibers strongly acts by a hydrogen bond between hydroxy groups of the cellulose fiber or the derivative, and defiberization does not proceed.

When a cellulose derivative having a substituent in which R_{C1} in the formula (2) is an alkyl group having 7 or more carbon atoms is used instead of the specific cellulose derivative, the glass transition temperature and melting point of the derivative decrease, and the heat resistance of the obtained molded product cannot be guaranteed.

When a cellulose derivative having a substituent in which R_{C2} in the formula (2) is an alkylene group having 1 carbon atom, i.e., a methylene group, is used instead of the group is unstable for heat and is thermally decomposed during the conjugating and molding process.

When a cellulose derivative having a substituent in which R_{C2} in the formula (2) is an alkylene group having 4 or more carbon atoms is used instead of the specific cellulose derivative, the proportion of oxygen atoms in the side chain is decreased to reduce the polarization, and the compatibility with cellulose decreases.

When a cellulose derivative having a substituent in which R_{C3} in the formula (2) is an alkylene group having 2 or less carbon atoms is used instead of the specific cellulose derivative, the glass transition temperature and melting point increase, and the temperature during conjugating and molding process increases.

When a cellulose derivative having a substituent in which R_{C3} in the formula (2) is an alkylene group having 7 or more carbon atoms is used instead of the specific cellulose derivative, the glass transition temperature and melting point of the derivative decrease, and the heat resistance of the obtained molded product cannot be guaranteed.

When a cellulose derivative having a substituent in which m in the formula (2) is 2 or less is used instead of the specific cellulose derivative, the strength, in particular, bending strength and bending elastic modulus, of the molded product manufactured using the molding material are inferior.

When a cellulose derivative having a substituent in which m in the formula (2) is 7 or more is used instead of the specific cellulose derivative, the molded product manufactured using the molding material has significantly poor shock resistance and so on.

When a cellulose derivative having a substituent in which R_{C1} in the formula (4) is a hydrogen atom is used instead of the specific cellulose derivative, the polarity of the side chain is increased, the compatibility with a resin is decreased, and the hygroscopic property of the molding material is increased, resulting in decreases in moisture resistance and water resistance.

When a cellulose derivative having a substituent in which R_{C1} in the formula (4) is an alkyl group having 7 or more carbon atoms is used instead of the specific cellulose derivative, the strength, shock resistance, and heat resistance of the molded product manufactured using the molding material are all inferior.

When a cellulose derivative having a substituent in which R_{C2} in the formula (4) is an alkylene group having 1 carbon atom, i.e., a methylene group, is used instead of the group is unstable for heat and is thermally decomposed during conjugating and molding process.

When a cellulose derivative having a substituent in which R_{C2} in the formula (4) is an alkylene group having 4 or more carbon atoms is used instead of the specific cellulose derivative, the proportion of oxygen atoms in the side chain is decreased to reduce the polarization, and the compatibility with cellulose decreases.

When a cellulose derivative having a substituent in which R_{C4} in the formula (4) is an alkylene group having 2 or less carbon atoms is used instead of the specific cellulose derivative, the glass transition temperature and melting point increase, and the temperature during conjugating and molding process increases.

When a cellulose derivative having a substituent in which R_{C4} in the formula (4) is an alkylene group having 7 or more carbon atoms is used instead of the specific cellulose derivative, the strength, shock resistance, and heat resistance of the molded product manufactured using the molding material are all inferior.

When a cellulose derivative having a substituent in which n in the formula (4) is 2 or less is used instead of the specific cellulose derivative, the strength, in particular, bending strength and bending elastic modulus, of the molded product manufactured using the molding material are inferior.

When a cellulose derivative having a substituent in which n in the formula (4) is 7 or more is used instead of the specific cellulose derivative, shock resistance and heat resistance of the molded product manufactured using the molding material are all inferior.

Even when the molding material includes a cellulose fiber and a specific cellulose derivative, if the content of the cellulose fiber in the molding material is less than the lower limit, the effects by including the above-described cellulose fiber are not sufficiently exhibited.

Even when the molding material includes a cellulose fiber and a specific cellulose derivative, if the content of the cellulose fiber in the molding material is higher than the upper limit, the content of the specific cellulose derivative is relatively decreased, the formability of the molded product and the strength, shock resistance, and heat resistance of the molded product are sharply decreased.

### [1-1] Cellulose Fiber

The molding material of the present disclosure includes a cellulose fiber.

The cellulose fiber is the main component of the molding material of the present disclosure and is a component that highly contributes to maintenance of the shape of the molded product manufactured using the molding material of the present disclosure and significantly affects the properties, such as strength, of the molded product.

Cellulose is an abundant natural material derived from plants. Accordingly, when a cellulose fiber is used, it is possible to appropriately respond to environmental problems and underground resource saving and so on, and it is also advantageous from the viewpoint of stable supply, cost reduction, and so on of a molding material and a molded product manufactured using it. Among various fibers, the cellulose fiber has particularly high theoretical strength and is advantageous also from the viewpoint of improving the strength of the molded product.

As the cellulose fiber, virgin pulp may be used, or waste paper, waste cloth, and so on may be reused.

The cellulose fiber is generally mainly composed of cellulose, but may include a component other than cellulose. Example of such component include hemicellulose and lignin.

The cellulose fiber may be subjected to treatment such as bleaching.

Examples of the cellulose fiber include cotton, linen, rayon, and cupra.

The content of the cellulose fiber in the molding material of the present disclosure is, as described above, 50 mass % or more and 70 mass % or less and may be 52 mass % or more and 68 mass % or less, 54 mass % or more and 66 mass % or less, or 56 mass % or more and 64 mass % or less.

Consequently, the above-described effects by the present disclosure are more significantly exhibited. In addition, the formability of the molded product can be more improved, which is also advantageous in improving the productivity of the molded product.

The average length of the cellulose fiber is not particularly limited, but may be 1 μm or more and 5000 μm or less or 1 μm or more and 400 μm or less.

Consequently, the shape stability, strength, and so on of the molded product manufactured using the molding material can be more improved. In addition, the dust generation in the molded product manufactured using the molding material can be more effectively prevented and suppressed. Furthermore, the occurrence of unwanted unevenness on the surface of the molded product manufactured using the molding material can be more effectively prevented. The fiber length of the cellulose fiber is determined by a method in accordance with ISO 16065-2:2007.

The average thickness of the cellulose fiber is not particularly limited, but may be 1 μm or more and 100 μm or less or 1 μm or more and 20 μm or less.

Consequently, the shape stability, strength, and so on of the molded product manufactured using the molding material can be more improved. In addition, the occurrence of unwanted unevenness on the surface of the molded product manufactured using the molding material can be more effectively prevented.

The average aspect ratio of the cellulose fiber, that is, the ratio of the average length to the average thickness, is not particularly limited, but may be 10 or more and 1000 or less or 15 or more and 100 or less.

Consequently, the shape stability, strength, and so on of the molded product manufactured using the molding material can be more improved. The dust generation in the molded product manufactured using the molding material can be more effectively prevented and suppressed. In addition, the occurrence of unwanted unevenness on the surface of the molded product manufactured using the molding material can be more effectively prevented.

### [1-2] Specific Cellulose Derivative

The molding material of the present disclosure includes a specific cellulose derivative.

The specific cellulose derivative is a compound in which a part of the hydrogen atoms constituting the hydroxy groups of cellulose is substituted with a chemical structure represented by the above formula (1) or (3) and another part of the hydrogen atoms is substituted with a chemical structure represented by the above formula (2) or (4).

Specifically, examples of the specific cellulose derivative include:
a cellulose derivative having chemical structures represented by the above formulae (1) and (2);
a cellulose derivative having chemical structures represented by the above formulae (1) and (4);
a cellulose derivative having chemical structures represented by the formulae (3) and (2); and
a cellulose derivative having chemical structures represented by the formulae (3) and (4).

In particular, the specific cellulose derivative may be an etherified cellulose derivative that is a cellulose derivative having chemical structures represented by the above formulae (1) and (2) or an esterified cellulose derivative that is a cellulose derivative having chemical structures represented by the above formulae (3) and (4).

In other words, the etherified cellulose derivative is a derivative in which at least a part of the hydrogen atoms constituting the hydroxy groups of cellulose is substituted with a chemical structure represented by the above formula (1) and a chemical structure represented by the above formula (2), and the esterified cellulose derivative is a derivative in which at least a part of the hydrogen atoms constituting the hydroxy groups of cellulose is substituted with a chemical structure represented by the above formula (3) and a chemical structure represented by the above formula (4).

R_{A} in the formula (1) is an alkyl group and may be an alkyl group having 1 to 10 carbon atoms, an alkyl group having 1 to 8 carbon atoms, or an alkyl group having 1 to 6 carbon atoms.

Consequently, the strength, shock resistance, and heat resistance of the molded product manufactured using the molding material can be more improved.

The specific cellulose derivative may have chemical structures having different conditions with each other in the molecule as the chemical structures represented by the above formula (1).

R_{C1} in the formula (2) is an alkyl group having 1 to 6 carbon atoms and may be alkyl group having 1 to 4 carbon atoms, an alkyl group having 1 to 3 carbon atoms, or an alkyl group having 1 or 2 carbon atoms.

Consequently, the strength, shock resistance, and heat resistance of the molded product manufactured using the molding material can be more improved.

R_{C2} in the formula (2) is an alkylene group having 2 or 3 carbon atoms and may be an alkylene group having 3 carbon atoms, i.e., may be a propylene group.

Consequently, the strength, shock resistance, and heat resistance of the molded product manufactured using the molding material can be more improved.

R_{C3} in the formula (2) is an alkylene group having 3 to 6 carbon atoms and may be an alkylene group having 3 to 5 carbon atoms, an alkylene group having 3 or 4 carbon atoms, or an alkylene group having 3 carbon atoms, i.e., a propylene group.

Consequently, the strength, shock resistance, and heat resistance of the molded product manufactured using the molding material can be more improved.

The integer m in the formula (2) is 3 or more and 6 or less and may be an integer of 3 or more and 5 or less, 3 or 4, or 3.

Consequently, the strength, shock resistance, and heat resistance of the molded product manufactured using the molding material can be more improved.

The specific cellulose derivative may have chemical structures having different conditions with each other in the molecule as the chemical structures represented by the above formula (2).

R_{B} in the formula (3) is an alkyl group and may be an alkyl group having 1 to 10 carbon atoms, an alkyl group having 2 to 8 carbon atoms, or an alkyl group having 3 to 5 carbon atoms.

Consequently, the strength, shock resistance, and heat resistance of the molded product manufactured using the molding material can be more improved.

The specific cellulose derivative may have chemical structures having different conditions with each other in the molecule as the chemical structures represented by the above formula (3).

R_{C1} in the formula (4) is an alkyl group having 1 to 6 carbon atoms and may be an alkyl group having 1 to 4 carbon atoms, an alkyl group having 1 to 3 carbon atoms, or an alkyl group having 1 or 2 carbon atoms.

Consequently, the strength, shock resistance, and heat resistance of the molded product manufactured using the molding material can be more improved.

R_{C2} in the formula (4) is an alkylene group having 2 or 3 carbon atoms and may be an alkylene group having 2 carbon atoms, i.e., an ethylene group.

Consequently, the strength, shock resistance, and heat resistance of the molded product manufactured using the molding material can be more improved.

R_{C4} in the formula (4) is an alkylene group having 3 to 6 carbon atoms and may be an alkylene group having 3 to 5 carbon atoms, an alkylene group having 3 or 4 carbon atoms, or an alkylene group having 3 carbon atoms, i.e., a propylene group.

Consequently, the strength, shock resistance, and heat resistance of the molded product manufactured using the molding material can be more improved.

The integer n in the formula (4) is an integer of 3 or more and 6 or less and may be an integer of 3 or more and 5 or less, 3 or 4, or 3.

Consequently, the strength, shock resistance, and heat resistance of the molded product manufactured using the molding material can be more improved.

The specific cellulose derivative may have chemical structures having different conditions with each other in the molecule as the chemical structures represented by the above formula (4).

In the specific cellulose derivative, the total value of the DS values of the chemical structures represented by the formulae (1) and (3), that is, the substitution degree that is the value corresponding to the number of hydrogen atoms that have been substituted with the chemical structures represented by the formulae (1) and (3) in the hydrogen atoms of all the hydroxy groups in the cellulose may be 1.5 or more and 2.7 or less, 1.6 or more and 2.5 or less, or 1.7 or more and 2.3 or less.

Consequently, the strength, shock resistance, and heat resistance of the molded product manufactured using the molding material can be more improved.

In the specific cellulose derivative, the total value of the DS values of the chemical structures represented by the formulae (2) and (4), that is, the substitution degree that is the value corresponding to the number of hydrogen atoms that have been substituted with the chemical structures represented by the formulae (2) and (4) in the hydrogen atoms of all the hydroxy groups in the cellulose may be 0.3 or more and 1.5 or less, 0.4 or more and 1.3 or less, or 0.5 or more and 1.1 or less.

Consequently, the strength, shock resistance, and heat resistance of the molded product manufactured using the molding material can be more improved.

In the specific cellulose derivative, the total value of the DS values of all substituents, that is, the substitution degree that is the value corresponding to the number of hydrogen atoms that have been substituted with substituents in the hydrogen atoms of all the hydroxy groups in the cellulose may be 2.0 or more and 2.7 or less, 2.2 or more and 2.7 or less, or 2.4 or more and 2.7 or less.

Consequently, the strength, shock resistance, and heat resistance of the molded product manufactured using the molding material can be more improved.

In particular, in the specific cellulose derivative, when the total value of the DS values of chemical structures represented by the formulae (1) and (3), the total value of the DS values of chemical structures represented by the formulae (2) and (4), and the total value of the DS values of all substituents satisfy the above-described conditions, the above-described effects can be more significantly exhibited.

The number average molecular weight of the specific cellulose derivative may be 10,000 or more and 400,000 or less, 20,000 or more and 300,000 or less, or 35,000 or more and 200,000 or less.

Consequently, the affinity and compatibility of the specific cellulose derivative to the cellulose fiber can be more improved, and the strength, shock resistance, and heat resistance of the molded product manufactured using the molding material can be more improved.

The glass transition temperature of the specific cellulose derivative may be 80° C. or more and 200° C. or less, 90° C. or more and 180° C. or less, or 100° C. or more and 170° C. or less.

Consequently, the affinity and compatibility of the specific cellulose derivative to the cellulose fiber can be more improved, and the strength, shock resistance, and heat resistance of the molded product manufactured using the molding material can be more improved.

The content of the specific cellulose derivative in the molding material may be 10 mass % or more and 40 mass % or less, 13 mass % or more and 30 mass % or less, or 15 mass % or more and 25 mass % or less.

Consequently, the strength, shock resistance, and heat resistance of the molded product manufactured using the molding material can be more improved.

In the molding material, a relationship of 0.14≤ XD/XC≤0.80, wherein XC [mass %] is the content of the cellulose fiber and XD [mass %] is the content of the specific cellulose derivative, may be satisfied, and a relationship of 0.19≤ XD/XC≤0.60 or 0.22≤ XD/XC≤0.50 may be satisfied.

Consequently, the strength, shock resistance, and heat resistance of the molded product manufactured using the molding material can be more improved.

### [1-3] Second Cellulose Derivative

The molding material of the present disclosure may further include a second cellulose derivative that is at least one selected from the group consisting of cellulose acetate propionate, cellulose acetate butyrate, and cellulose acetate, in addition to the above-described cellulose fiber and specific cellulose derivative.

These second cellulose derivatives are excellent in the affinity and compatibility with the specific cellulose derivative, and the strength, shock resistance, and heat resistance of the molded product manufactured using the molding material can be more improved by including such a second cellulose derivative.

The content of the second cellulose derivative in the molding material may be 10 mass % or more and 40 mass % or less, 12 mass % or more and 36 mass % or less, or 14 mass % or more and 32 mass % or less.

Consequently, the strength, shock resistance, and heat resistance of the molded product manufactured using the molding material can be further improved.

### [1-4] Flame Retardant

The molding material of the present disclosure may further include a flame retardant.

Consequently, the flame retardance of the molded product manufactured using the molding material of the present disclosure can be improved.

Examples of the flame retardant include a bromine flame retardant, a chlorine flame retardant, a phosphorus-containing flame retardant, a silicon-containing flame retardant, a nitrogen compound-based flame retardant, and an inorganic flame retardant.

Among these flame retardants, the flame retardant may be a phosphorus-containing flame retardant or a silicon-containing flame retardant, because they are not thermally decomposed and do not generate a hydrogen halide during mixing and kneading with other components or molding processing and therefore do not corrode the processing machine and molding die and do not deteriorate the working environment. In addition, they are less likely to have an adverse effect on the environment due to diffusion of a halogen or generation of dioxin by decomposition during incineration disposal.

Examples of the phosphorus-containing flame retardant include organic phosphorus compounds such as a phosphoric acid ester, a phosphoric acid condensed ester, and a polyphosphate.

Examples of the phosphoric acid ester include trimethyl phosphate, triethyl phosphate, tributyl phosphate, tri (2-ethylhexyl) phosphate, tributoxyethyl phosphate, triphenyl phosphate, tricresyl phosphate, trixylenyl phosphate, tris(isopropylphenyl) phosphate, tris(phenylphenyl) phosphate, trinaphthyl phosphate, cresy diphenyl phosphate, xylenyl diphenyl phosphate, diphenyl (2-ethylhexyl) phosphate, di (isopropylphenyl) phenyl phosphate, monoisodecyl phosphate, 2-acryloyloxyethyl acid phosphate, 2-methacryloyloxyethyl acid phosphate, diphenyl-2-acryloyloxyethyl phosphate, diphenyl-2-methacryloyloxyethyl phosphate, melamine phosphate, dimelamine phosphate, melamine pyrophosphate, triphenylphosphine oxide, tricresylphosphine oxide, diphenyl methanephosphonate, and diethyl phenylphosphonate.

Examples of the phosphoric acid condensed ester include aromatic phosphoric acid condensed esters such as resorcinol polyphenyl phosphate, resorcinol poly (di-2,6-xylyl) phosphate, bisphenol A polycresyl phosphate, hydroquinone poly (2,6-xylyl) phosphate, and condensates thereof.

Examples of the phosphoric acid condensed ester also include polyphosphates that are salts of phosphoric acid or polyphosphoric acid and metals of Groups 1 to 14 of the periodic table, ammonia, aliphatic amine, and aromatic amine. Typical examples of the salts of the polyphosphate include metal salts such as a lithium salt, a sodium salt, a calcium salt, a barium salt, an iron (II) salt, an iron (III) salt, and an aluminum salt; aliphatic amine salts such as a methylamine salt, an ethylamine salt, a diethylamine salt, a triethylamine salt, an ethylenediamine salt, and a piperazine salt; and aromatic amine salts such as a pyridine salt and a triazine salt.

In addition to the above, the examples include halogen-containing phosphoric acid esters such as tris (chloroethyl) phosphate, tris (dichloropropyl) phosphate, and tris (B-chloropropyl) phosphate; phosphazene compounds having a structure in which a phosphorus atom and a nitrogen atom are bonded by a double bond; and phosphoric acid ester amides.

Examples of the silicon-containing flame retardant include organic silicon compounds with a two-dimensional or three-dimensional structure, and polydimethylsiloxane and polydimethylsiloxane of which a side-chain or terminal methyl group is substituted or modified with a hydrogen atom or a substituted or unsubstituted aliphatic hydrocarbon group or aromatic hydrocarbon group, i.e., so-called silicone oil or modified silicone oil.

Examples of the substituted or unsubstituted aliphatic hydrocarbon group or aromatic hydrocarbon group include an alkyl group, a cycloalkyl group, a phenyl group, a benzyl group, an amino group, an epoxy group, a polyether group, a carboxyl group, a mercapto group, a chloroalkyl group, an alkyl higher alcohol ester group, an alcohol group, an aralkyl group, a vinyl group, and a trifluoromethyl group.

As flame retardants other than the phosphorus-containing flame retardant and silicon-containing flame retardant, for example, inorganic flame retardants, such as magnesium hydroxide, aluminum hydroxide, antimony trioxide, antimony pentoxide, sodium antimonate, zinc hydroxystannate, zinc stannate, metastannic acid, tin oxide, a tin oxide salt, zinc sulfate, zinc oxide, ferrous oxide, ferric oxide, stannous oxide, stannic oxide, zinc borate, ammonium borate, ammonium octamolybdate, a metal salt of tungstic acid, a complex oxide of tungsten and a metalloid, ammonium sulfamate, ammonium bromide, a zirconium compound, a guanidine compound, a fluorine compound, graphite, and swellable graphite, can be used.

When the molding material includes a flame retardant, the content of the flame retardant can be 1 part by mass or more and 30 parts by mass or less when the total content of the cellulose fiber and the specific cellulose derivative is defined as 100 parts by mass.

Consequently, the flame retardance of the molded product manufactured using the molding material of the present disclosure can be more improved, while more effectively exhibiting the above-described effects of the present disclosure.

### [1-5] Antioxidant

The molding material of the present disclosure may further include an antioxidant.

Consequently, the stability of a resin against heating during kneading and a molding process is improved.

Examples of the antioxidant include a phosphorous antioxidant and a hindered phenolic antioxidant (for example, “Irganox 1010”, “Irganox 1076”, and “Irganox 3114” manufactured by BASF Japan Ltd., and “SUMILIZER GP” manufactured by Sumitomo Chemical Co., Ltd.).

When the molding material includes an antioxidant, the content of the antioxidant can be 0.05 parts by mass or more and 2.0 parts by mass or less when the total mass of the cellulose fiber and the specific cellulose derivative is defined as 100 parts by mass.

Consequently, the scratch resistance and the antifouling property can be more suitably improved while more suitably suppressing decreases in the shock resistance, formability, rigidity, bending strength, heat resistance, and so on of the specific cellulose derivative.

### [1-6] Other Components

The molding material of the present disclosure may include other components than the above-mentioned components. Hereinafter, such components will also be referred to as “other components” in this category.

Examples of the other components include a coloring agent, an insect repellent, an antifungal agent, an antibacterial agent, an antistatic agent, a flame-retardant auxiliary, an ultraviolet absorber, an agglomeration inhibitor, a mold release agent, a processing auxiliary, an anti-drip agent, a cellulose derivative other than the above, a resin material, and a plasticizer.

However, the content of the other components in the molding material of the present disclosure can be 10 mass % or less, 5 mass % or less, or 3 mass % or less.

### [2] Method for Manufacturing Molding Material

A method for manufacturing the molding material of the present disclosure will now be described.

The molding material of the present disclosure can be manufactured by, for example, mixing the above-described components. In this case, the timing of mixing the components may be the same or may be different.

The molding material of the present disclosure may be manufactured by, for example, kneading the above-described components. The kneading of the components can be performed using, for example, a single-screw kneader, a twin-screw kneader, a multi-screw kneader, a mixer, or a roll banbury machine.

The strand-shaped molding material obtained by kneading may be formed into, for example, a pellet-shaped molding material by pelletizing processing using a pelletizer of a strand system, a watering hot cut system, or the like.

As the method for manufacturing a molding material, the following method may be used. That is, a kneaded product of the above-described components is formed into a sheet shape and then may be formed, for example, into a pellet-shaped molding material by cutting into a desired shape using a shredder. The method for forming a kneaded product into a sheet shape is not particularly limited, but examples thereof include a method by first depositing the kneaded product into a sheet-shaped sediment in the air, compressing the sediment with a calendar device to remove the air and increase the density, subsequently heating the compressed sediment by a heating furnace without contact, and then performing heat pressing with a heat press device. The shape and size of the pellet obtained by cutting are not particularly limited, but the pellet can be, for example, an approximate rectangular parallelepiped with one piece length of 2 mm or more and 5 mm or less.

The cellulose fiber that is used for manufacturing the molding material of the present disclosure may be defiberized in advance. In particular, a cellulose fiber source including a cellulose fiber, such as waste paper, may be used after defiberization.

### [3] Molded Product

A molded product manufactured using the molding material of the present disclosure will now be described. The molded product according to the present

disclosure includes a cellulose fiber and a specific cellulose derivative, and the content of the cellulose fiber is 50 mass % or more and 70 mass % or less.

The molded product according to the present disclosure can be manufactured using the above-described molding material.

Consequently, it is possible to provide a molded product including a cellulose fiber in a predetermined content range, i.e., a sufficiently high content of 50 mass % or more and 70 mass % or less and having excellent strength, shock resistance, and heat resistance.

When a cellulose fiber, which is an abundant natural material derived from plants, is included at a high content, it is possible to appropriately respond to environmental problems and underground resource saving and so on, and also it is advantageous from the viewpoint of stable supply, cost reduction, and so on of a molded product. A cellulose fiber is a component that is found in large amounts in, for example, waste paper and waste cloth in addition to virgin pulp, and is also advantageous from the viewpoint of promoting the effective reuse of resources.

The specific cellulose derivative can be suitably obtained using cellulose such as the above as a raw material, and is a component generally having excellent biodegradability. Consequently, also as an entire molded product, it is possible to appropriately respond to environmental problems and so on.

Each component constituting the molded product can satisfy the conditions described in the paragraphs [1-1] to

### [1-6] Above.

The shape of the molded product is not particularly limited, and may be any of, for example, sheet-like, block-like, spherical, and three-dimensional shapes.

The molded product may be used for any application, and examples of the application include various housings such as the housing of a printer, ink cartridges, and various containers.

In particular, the molded product according to the present disclosure can be suitably applied to an ink cartridge and so on where dust generation is a particular problem, because the affinity between the cellulose fiber and the specific cellulose derivative is high, and dust generation is effectively prevented.

The molded product according to the present disclosure may be manufactured by any method, but can be suitably manufactured by, for example, injection molding, pressing molding, or the like using the above-described molding material of the present disclosure.

Although the suitable embodiments of the present disclosure have been described above, the present disclosure is not limited thereto.

### EXAMPLES

Specific examples of the present disclosure will now be described.

### [4] Synthesis of Cellulose Derivative

### Synthesis Example 1

2-2-(2-Propoxyethoxy) ethoxyethanol (29.2 g, 0.1 mol) manufactured by BOC Sciences was placed in a reaction flask equipped with a drying tube, and tetrahydrofuran (200 mL) dried with sodium hydride in advance was added thereto for dissolution. Subsequently, methyl 4-bromobutyrate (72.4 g, 0.4 mol) manufactured by Tokyo Chemical Industry Co., Ltd. and sodium hydride (3.6 g, 0.15 mol) were added to the solution. As the sodium hydride, 50% oily NaH washed with dry toluene and filtered in advance was used. The reaction mixture was stirred at room temperature for 24 hours. The solvent was distilled off, and water (25 mL) was added thereto, followed by extraction with ether (100 mL). The ether layer was washed with water twice and dried with anhydrous magnesium sulfate. Ether was distilled off, and the residue was then reprecipitated with methanol to obtain 5,8,11,14-tetraoxaheptadecanoic acid methyl ester.

The ester derivative, 5,8,11,14-tetraoxaheptadecanoic acid methyl ester, obtained as above was added to a 200-mL three neck flask containing a 25% sodium hydroxide aqueous solution (40 mL), followed by stirring at room temperature for 6 hours. The solution was changed to weak acid by dropwise addition of dilute hydrochloric acid, followed by extraction with saturated saline-chloroform to obtain 5,8,11,14-tetraoxaheptadecanoic acid. A mixture of the obtained carboxylic acid derivative (27.8 g, 0.1 mol) and thionyl chloride (47.6 g, 0.4 mol) was refluxed at 80° C. for 3 hours. Excessive thionyl chloride was removed under reduced pressure, and the distillation was continued to obtain an acid chloride as an intermediate.

Cellulose (manufactured by Nippon Paper Industries Co., Ltd., FLOCK W50, 1.90 g, 11.76 mmol) was placed in a 200-mL three neck flask, and N-methyl-2-pyrrolidinone (manufactured by Kanto Chemical Co., Ltd., 25.4 mL) and pyridine (manufactured by Kanto Chemical Co., Ltd., 3.3 ml) were added thereto as solvents, followed by mechanical stirring at 300 rpm for 4 hours. The inner temperature was cooled to −4° C., and the acid chloride (1.75 g, 5.88 mmol) and propionic acid chloride (manufactured by Kanto Chemical Co., Ltd., 3.26 g, 35.27 mmol) were dropwise added thereto, followed by reaction at an inner temperature of 90° C. for 12 hours. The inner temperature was then cooled to 65° C., and methanol (42.9 mL) was added thereto to stop the reaction. After pure water (6.3 mL) added thereto and filtering was performed under reduced pressure, the residue was dispersed and stirred in methanol (23.8 mL), followed by filtration under reduced pressure. This procedure was repeated 5 times, and vacuum drying was performed for 12 hours to obtain a cellulose derivative.

### Synthesis Examples 2 to 19

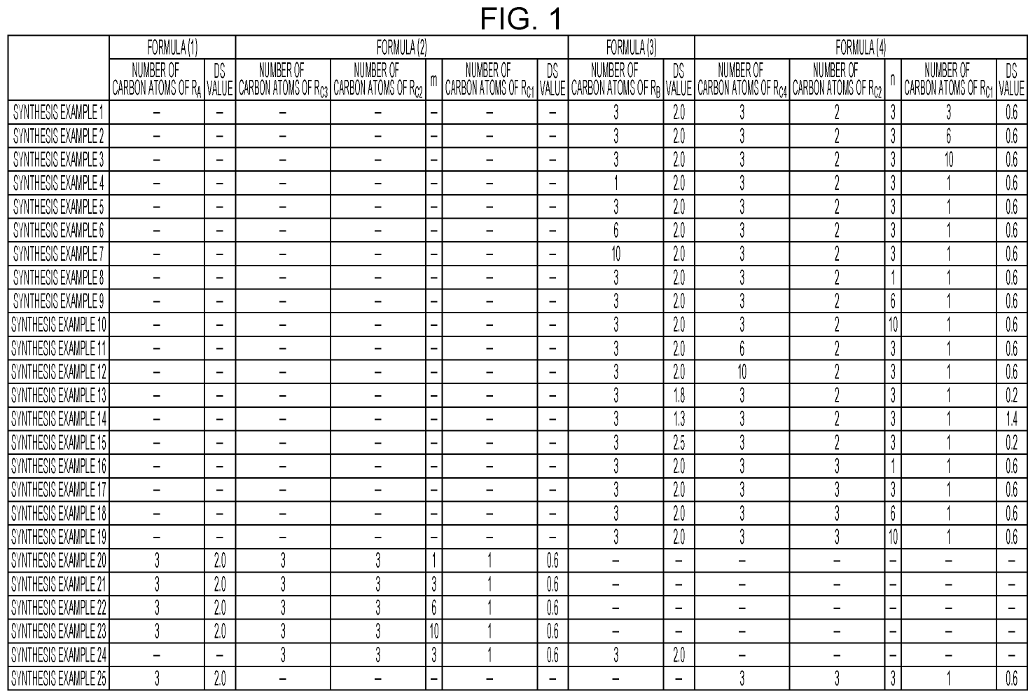

Cellulose derivatives were synthesized as in Synthesis Example 1 except that the types and amounts of the components reacting with cellulose as the raw material were changed such that the configurations of the cellulose derivatives were as shown in FIG. 1.

### Synthesis Example 20

1,3-Dibromopropane (60.6 g, 0.3 mol) manufactured by Tokyo Chemical Industry Co., Ltd. and sodium hydride (2.4 g, 0.1 mol) were added to tetrahydrofuran (200 mL) dried with sodium hydride in advance in a reaction flask equipped with a drying tube, and 2-2-(2-propoxyethoxy) ethoxyethanol (14.6 g, 0.05 mol) manufactured by BOC Sciences was dropwise added thereto. As the sodium hydride, 50% oily NaH washed with dry toluene and filtered in advance was used. The reaction mixture was stirred at room temperature for 24 hours. The solvent was distilled off, and water (25 mL) was then added thereto, followed by extraction with ether (100 mL). The ether layer was washed with water twice and dried with anhydrous magnesium sulfate. Ether was distilled off, and the residue was then reprecipitated with methanol to obtain 1-bromo-5,8,11,14-tetraoxahexadecane.

Cellulose (manufactured by Nippon Paper Industries Co., Ltd., FLOCK W50, 1.90 g, 11.8 mmol) was placed in a 200-mL three neck flask, and dimethylformamide (manufactured by Kanto Chemical Co., Ltd., 25.4 mL) and sodium hydride (1.2 g, 50 mmol) were added thereto as solvents, followed by mechanical stirring at 300 rpm for 4 hours. The terminal bromo derivative (1.53 g, 5.88 mmol) and 1-bromopropane (manufactured by Kanto Chemical Co., Ltd., 4.55 g, 35.3 mmol) were dropwise added thereto, followed by reaction at an internal temperature of 60° C. for 12 hours. The inner temperature was then cooled to room temperature, and methanol (42.9 mL) was added thereto to stop the reaction. After adding pure water (6.3 mL) and filtering under reduced pressure, the residue was dispersed and stirred in methanol (23.8 mL), followed by filtration under reduced pressure. This procedure was repeated 5 times, and vacuum drying was performed for 12 hours to obtain a cellulose derivative. Synthesis Examples 21 to 23

Cellulose derivatives were synthesized as in Synthesis Example 20 except that the types and amounts of the components reacting with cellulose as the raw material were changed such that the configurations of the cellulose derivatives were as shown in FIG. 1.

### Synthesis Example 24

Cellulose (manufactured by Nippon Paper Industries Co., Ltd., FLOCK W50, 1.90 g, 11.8 mmol) was placed in a 200-mL three neck flask, and dimethylformamide (manufactured by Kanto Chemical Co., Ltd., 25.4 mL) and sodium hydride (1.2 g, 50 mmol) were added thereto as solvents, followed by mechanical stirring at 300 rpm for 4 hours. The terminal bromo intermediate (1.53 g, 5.88 mmol) of Synthesis Example 20 was dropwise added thereto, followed by reaction at an internal temperature of 60° C. for 12 hours. The inner temperature was then cooled to room temperature, and methanol (42.9 mL) was added thereto to stop the reaction. After adding pure water (6.3 mL) and filtering under reduced pressure, the residue was dispersed and stirred in methanol (23.8 mL), followed by filtration under reduced pressure. This procedure was repeated 5 times, and vacuum drying was performed for 12 hours.

The obtained dried material was placed in a 200-mL three neck flask, and N-methyl-2-pyrrolidinone (manufactured by Kanto Chemical Co., Ltd., 25.4 mL) and pyridine (manufactured by Kanto Chemical Co., Ltd., 3.3 mL) were added thereto as solvents, followed by mechanical stirring at 300 rpm for 4 hours. The inner temperature was cooled to −4° C., and propionic acid chloride (manufactured by Kanto Chemical Co., Ltd., 3.26 g, 35.3 mmol) was dropwise added thereto, followed by reaction at an inner temperature of 90° C. for 12 hours. The inner temperature was then cooled to 65° C., and methanol (42.9 mL) was added thereto to stop the reaction. After adding pure water (6.3 mL) and filtering under reduced pressure, the residue was dispersed and stirred in methanol (23.8 mL), followed by filtration under reduced pressure. This procedure was repeated 5 times, and vacuum drying was performed for 12 hours to obtain a cellulose derivative.

### Synthesis Example 25

Cellulose (manufactured by Nippon Paper Industries Co., Ltd., FLOCK W50, 1.90 g, 11.8 mmol) was placed in a 200-mL three neck flask, and dimethylformamide (manufactured by Kanto Chemical Co., Ltd., 25.4 mL) and sodium hydride (1.2 g, 50 mmol) were added thereto as solvents, followed by mechanical stirring at 300 rpm for 4 hours. 1-Bromopropane (manufactured by Kanto Chemical Co., Ltd., 4.55 g, 35.3 mmol) was dropwise added thereto, followed by reaction at an internal temperature of 60° C. for 12 hours. The inner temperature was then cooled to room temperature, and methanol (42.9 mL) was added thereto to stop the reaction. After adding pure water (6.3 mL) and filtering under reduced pressure, the residue was dispersed and stirred in methanol (23.8 mL), followed by filtration under reduced pressure. This procedure was repeated 5 times, and vacuum drying was performed for 12 hours.

The obtained dried material was placed in a 200-mL three neck flask, and N-methyl-2-pyrrolidinone (manufactured by Kanto Chemical Co., Ltd., 25.4 mL) and pyridine (manufactured by Kanto Chemical Co., Ltd., 3.3 mL) were added thereto as solvents, followed by mechanical stirring at 300 rpm for 4 hours. The inner temperature was cooled to −4° C., and the intermediate (1.75 g, 5.88 mmol) of the acid chloride of Synthesis Example 1 was dropwise added thereto, followed by reaction at an inner temperature of 90° C. for 12 hours. The inner temperature was then cooled to 65° C., and methanol (43.9 mL) was added thereto to stop the reaction. After adding pure water (6.3 mL) and filtering under reduced pressure, the residue was dispersed and stirred in methanol (23.8 mL), followed by filtration under reduced pressure. This procedure was repeated 5 times, and vacuum drying was performed for 12 hours to obtain a cellulose derivative.

The conditions of the cellulose derivative synthesized in each Synthesis Example are collectively shown in FIG. 1.

### [5] Preparation of Molding Material

### Example 1

A cellulose fiber (manufactured by Empresas CMPC S.A., Guaiba BEKP, 60 parts by mass), the cellulose derivative (20 parts by mass) synthesized in Synthesis Example 1, and cellulose acetate butyrate (manufactured by Eastman Chemical Company, CAB-381-20, 20 parts by mass) were weighed. Subsequently, these materials were charged and kneaded in a twin-screw kneader (manufactured by Technovel Corporation, KZW15TW-45 MG). The kneading conditions were a maximum heating temperature of 180° C. and an extrusion output of 1 kg/hr. Subsequently, the kneaded material was processed into a strand shape and then into a pellet-shaped molding material with a pelletizer.

### Examples 2 to 25

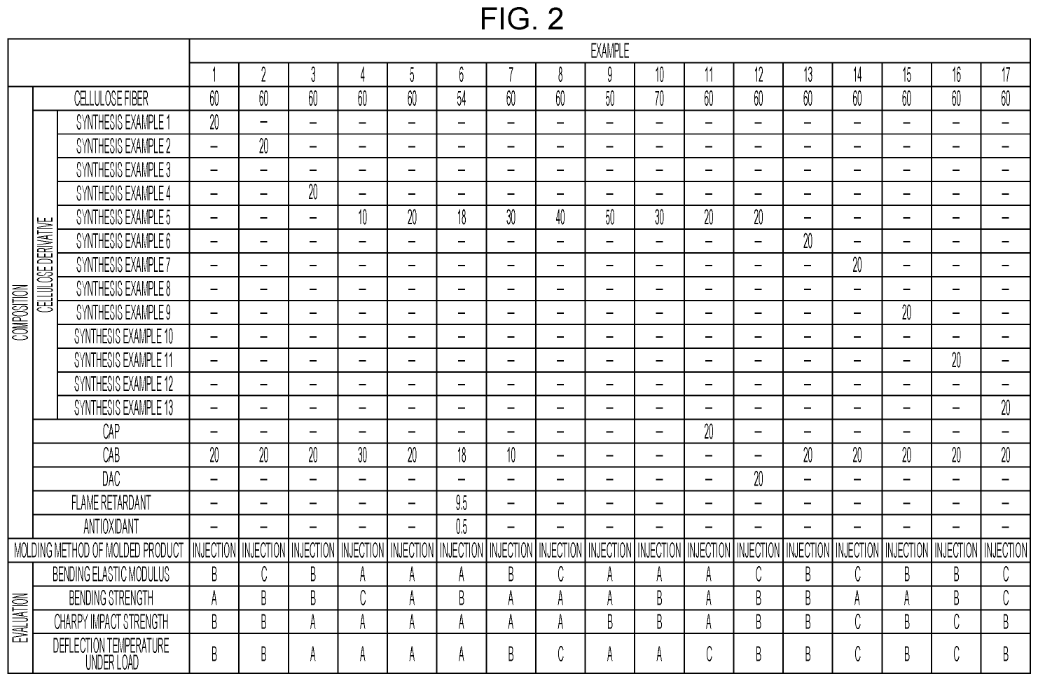

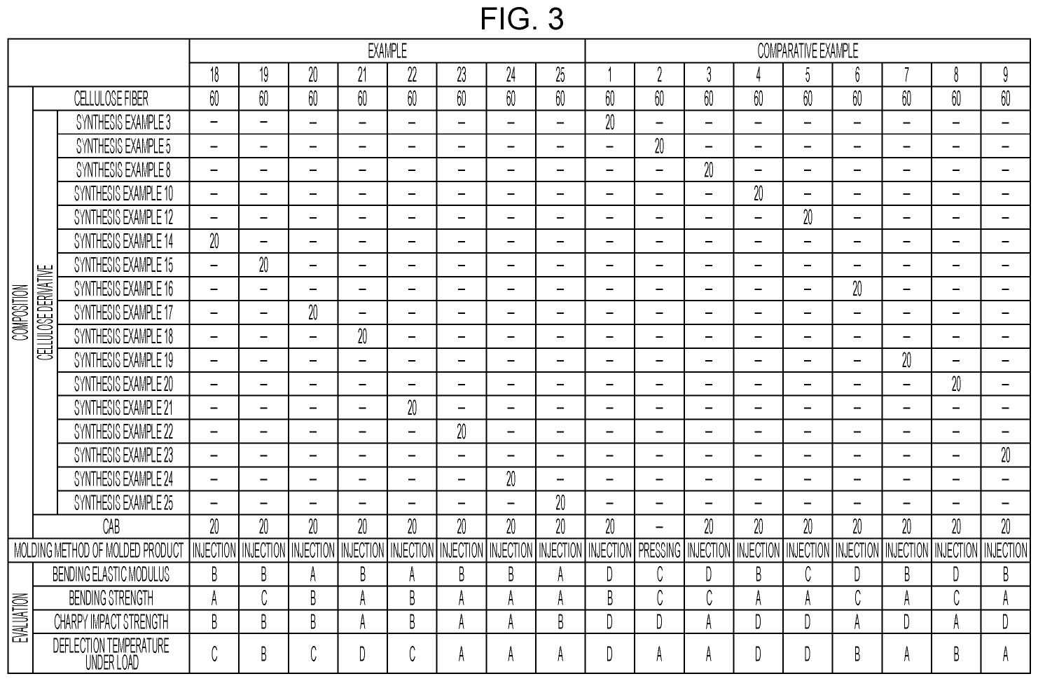

Pellet-shaped molding materials were prepared as in Example 1 except that the types of the components supplied to kneading and the compounding ratio of each component were changed as shown in FIGS. 2 and 3.

### Comparative Examples 1 to 9

Pellet-shaped molding materials were prepared as in Example 1 except that the types of the components supplied to kneading and the compounding ratio of each component were changed as shown in FIG. 3.

### [5] Manufacturing of Molded Product

The molding materials of Examples 1 to 25 and Comparative Examples 1 and 3 to 9 were each injection molded using an injection molding machine (manufactured by Nissei Plastic Industrial Co., Ltd., THX40-5V) to manufacture a molded product for Charpy impact strength evaluation and molded products for bending strength evaluation, bending elastic modulus evaluation, and temperature of deflection under load evaluation, described later. The heating temperature of the molding materials during injection molding was 200° C. The molded product for the Charpy impact strength evaluation was a rectangular plate-shaped molded product with a long side of 80 mm+2 mm, a short side of 4.0 mm+0.2 mm, and a thickness of 10.0 mm+0.2 mm, and the molded products for bending strength evaluation, bending elastic modulus evaluation, and temperature of deflection under load evaluation were each a rectangular plate-shaped molded product with a long side of 80 mm+2 mm, a short side of 10.0 mm+0.2 mm, and a thickness of 4.0 mm+0.2 mm.

The molding material of Comparative Example 2 was press-molded using a pressing apparatus (manufactured by Towa Seiki Co., Ltd., Hydraulic press PHKS-40ABS) to manufacture a molded product for Charpy impact strength evaluation and molded products for bending strength evaluation, bending elastic modulus evaluation, and temperature of deflection under load evaluation, described later. The heating temperature of the molding materials during pressing molding was 200° C. The molded product for the Charpy impact strength evaluation was a rectangular plate-shaped molded product with a long side of 80 mm+2 mm, a short side of 4.0 mm+0.2 mm, and a thickness of 10.0 mm+0.2 mm, and the molded products for bending strength evaluation, bending elastic modulus evaluation, and temperature of deflection under load evaluation were rectangular plate-shaped molded products with a long side of 80 mm+2 mm, a short side of 10.0 mm+0.2 mm, and a thickness of 4.0 mm+0.2 mm.

### [6] Evaluation

The molded products of Examples and Comparative Examples were subjected to the following evaluations.

### [6-1] Charpy Impact Strength

The Charpy impact strength of each of the molded products for Charpy impact strength evaluation of Examples and Comparative Examples manufactured as described in the above paragraph [5] was measured using Impact Tester IT manufactured by Toyo Seiki Seisaku-sho, Ltd. in accordance with ISO 179 (JIS K7111) and evaluated according to the following criteria. In the measurement of Charpy impact strength, the weight of the hammer was 4 J (WR 2.14 N/m), the lifting angle was 150°, the remaining notch width was 8.0 mm+0.2 mm, and the notch angle was 45°.

A: Charpy impact strength of 10 KJ/m² or more;

B: Charpy impact strength of 8 KJ/m² or more and less than 10 kJ/m²;

C: Charpy impact strength of 6 kJ/m² or more and less than 8 KJ/m²; and

D: Charpy impact strength of less than 6 KJ/m².

### [6-2] Bending Strength

The bending strength of each of the molded products for bending strength evaluation of Examples and Comparative Examples manufactured as described in the above paragraph [5] was measured using 68TM-30 manufactured by Instron in accordance with ISO 178 (JIS K7171) and evaluated according to the following criteria. In the measurement of bending strength, the distance between fulcrums was set to 64 mm.

A: bending strength of 60 MPa or more;

B: bending strength of 40 MPa or more and less than 60 MPa;

C: bending strength of 20 MPa or more and less than 40 MPa; and

D: bending strength of less than 20 MPa.

### [6-3] Bending Elastic Modulus

The bending elastic modulus of each of the molded products for bending elastic modulus evaluation of Examples and Comparative Examples manufactured as described in the above paragraph [5] was measured using 68TM-30 manufactured by Instron in accordance with ISO 178 (JIS K7171) and evaluated according to the following criteria. In the measurement of bending elastic modulus, the distance between fulcrums was set to 64 mm.

A: bending elastic modulus of 2.0 GPa or more;

B: bending elastic modulus of 1.5 GPa or more and less than 2.0 GPa;

C: bending elastic modulus of 1.0 GPa or more and less than 1.5 GPa; and

D: bending elastic modulus of less than 1.0 GPa.

### [6-4] Temperature of Deflection Under Load

The temperature of deflection under load of each of the molded products for temperature of deflection under load evaluation of Examples and Comparative Examples manufactured as described in the above paragraph [5] was measured using HDT Tester 3M-2: flatwise system manufactured by Toyo Seiki Seisaku-sho, Ltd. in accordance with ISO 75 (JIS K7191) and evaluated according to the following criteria. Three point bending with a bending stress of 1.8 MPa was performed in a thermostat under conditions of a distance between fulcrums of 64 mm, a heating starting temperature of 30° C., a temperature increase rate of 120° C./hr, and a heating end temperature of 220° C., and the temperature at which the displacement reached 0.34 mm was defined as temperature of deflection under load.

A: temperature of deflection under load of 120° C. or more;

B: temperature of deflection under load of 100° C. or more and less than 120° C.;

C: temperature of deflection under load of 80° C. or more and less than 100° C.; and

D: temperature of deflection under load of less than 80° C.

These results are collectively shown in FIGS. 2 and 3 together with the compositions of the molding materials obtained in Examples and Comparative Examples and the methods for molding the molded products using the molding materials.

In FIGS. 2 and 3, cellulose fiber (manufactured by Empresas CMPC S.A., Guaiba BEKP) is shown as “Cellulose fiber”, cellulose acetate propionate (manufactured by Eastman Chemical Company, CAP-482-20) is shown as “CAP” cellulose acetate butyrate (manufactured by Eastman Chemical Company, CAB-381-20) is shown as “CAB”, cellulose acetate (manufactured by Daicel Miraizu Ltd., DAC: L-70) is shown as “DAC”, triphenyl phosphate is shown as “Flame retardant”, and Irganox (registered trademark) 1010 is shown as “Antioxidant”. The numerical value for each component in FIGS. 2 and 3 indicates the content in terms of mass %.

As obvious from FIGS. 2 and 3, excellent results were obtained in each Example. In contrast, in Comparative Examples, satisfactory results were not obtained.

What is claimed is:

1. A molding material comprising:
a cellulose fiber; and
a specific cellulose derivative in which a part of hydrogen atoms constituting hydroxy groups of cellulose is substituted with a chemical structure represented by a following formula (1) or (3) and another part of the hydrogen atoms is substituted with a chemical structure represented by a following formula (2) or (4), wherein
a content of the cellulose fiber is 50 mass % or more and 70 mass % or less:
—R_{A} (1)
wherein, R_{A} is an alkyl group;
—R_{C3}—(OR_{C2})ₘ—OR_{C1} (2)
wherein, R_{C1} is an alkyl group having 1 to 6 carbon atoms, R_{C2} is an alkylene group having 2 or 3 carbon atoms, R_{C3} is an alkylene group having 3 to 6 carbon atoms, and m is an integer of 3 or more and 6 or less;
—(C═O)R_{B} (3)
wherein, R_{B} is an alkyl group; and
—(C═O)R_{C4}—(OR_{C2})ₙ—OR_{C1} (4)
wherein, R_{C1} is an alkyl group having 1 to 6 carbon atoms, R_{C2} is an alkylene group having 2 or 3 carbon atoms, R_{C4} is an alkylene group having 3 to 6 carbon atoms, and n is an integer of 3 or more and 6 or less.

2. The molding material according to claim 1, wherein
a content of the specific cellulose derivative is 10 mass % or more and 40 mass % or less.

3. The molding material according to claim 1, wherein 0.14≤ XD/XC≤0.80, where XC [mass %] is a content of the cellulose fiber, and XD [mass %] is a content of the specific cellulose derivative in the molding material.

4. The molding material according to claim 1, comprising the specific cellulose derivative in which the R_{A} is an alkyl group having 1 to 10 carbon atoms.

5. The molding material according to claim 1, further comprising:
a second cellulose derivative that is at least one selected from the group consisting of cellulose acetate propionate, cellulose acetate butyrate, and cellulose acetate.

6. The molding material according to claim 5, wherein
a content of the second cellulose derivative is 10 mass % or more and 40 mass % or less.

7. The molding material according to claim 1, wherein
in the specific cellulose derivative,
a total value of DS values of chemical structures represented by the formula (1) and the formula (3) is 1.5 or more and 2.7 or less,
a total value of DS values of chemical structures represented by the formula (2) and the formula (4) is 0.3 or more and 1.5 or less, and
a total value of DS values of all substituents is 2.0 or more and 2.7 or less.

8. The molding material according to claim 1, further comprising:
a flame retardant.

9. The molding material according to claim 1, further
